(19) United States
(12) Patent Application Publication
(10) Pub. No.: US 2018/0102615 A1
(43) Pub. Date: Apr. 12, 2018

(54) CONNECTOR AND CONNECTOR UNIT

(71) Applicant: DAI-ICHI SEIKO CO., LTD., Kyoto-shi (JP)

(72) Inventors: Takayoshi Endo, Shizuoka-shi (JP); Koji Hanaki, Shizuoka-shi (JP)

(21) Appl. No.: 15/717,220

(22) Filed: Sep. 27, 2017

(30) Foreign Application Priority Data
Oct. 6, 2016 (JP) 2016-198516

(51) Int. Cl. H01R 24/22; H01R 24/70

(52) U.S. Cl. CPC H01R 24/22; H01R 24/70

(57) ABSTRACT

A connector includes a ground terminal and a signal terminal. The ground terminal includes a body and an electrically conductive resilient contact plate, which is supported inside the body, extends from an opening on the +Y side toward an opening through which a counterpart ground terminal is inserted, and includes a contact against which the counterpart contact terminal abuts. The signal terminal includes a body, which is different from the body, and an electrically conductive contact plate, which is supported inside the body, extends from an opening on the +Y side toward an opening through which a counterpart signal terminal is inserted, and includes a contact against which the counterpart signal terminal abuts. The dimension from the opening to the contact is shorter than the dimension from the opening to the contact.

### CROSS-REFERENCE TO RELATED APPLICATION

This application claims the benefit of Japanese Patent Application No. 2016-198516, filed on Oct. 6, 2016, the entire disclosure of which is incorporated by reference herein.

### FIELD

This application relates to a connector and a connector unit.

### BACKGROUND

A connector used for supplying power or transmitting signals may cause, when inserted into or removed from a semiconductor or electronic component, an excessive electric stress on such a component connected to the connector. One known connector intended to reduce such stress includes the first mate last break (FMLB) structure, which allows ground terminals to come into contact with each other prior to contact between signal terminals when the male connector and the female connector become mated together, and allows the ground terminals to be disconnected from each other after disconnection of the signal terminals from each other when the male connector and the female connector become unmated (see Patent Literature 1, for example).

Patent Literature 1 Unexamined Japanese Utility Model Application Kokai Publication No. H6-80277

### SUMMARY

The female connector described in Patent Literature 1 includes a housing as well as a power supply terminal and a ground terminal that are contained in the housing. The ground terminal is formed so as to have a longer end than the end of the power supply terminal, and is placed inside the housing. Hence, the housing needs to be larger (longer) by the length of the longer portion of the end of the ground terminal. As a result, the structure described in Patent Literature 1 may necessitate an increase in the size of the connector itself.

The present disclosure has been created under such circumstances, and an objective of the disclosure is to prevent a connector and a connector unit from being larger while the FMLB structure is included.

To achieve the above-described objective, a connector according to a first aspect of the present disclosure includes:

a first terminal including:
a first body; and
a first contact plate that is electrically conductive and is supported inside the first body, the first contact plate extending from one opening of the first body toward an other opening of the first body through which a first counterpart terminal is inserted, and including a first contact against which the first counterpart terminal abuts; and
   a second terminal including:
a second body different from the first body; and
a second contact plate that is electrically conductive and is supported inside the second body, the second contact plate extending from one opening of the second body toward an other opening of the second body through which a second counterpart terminal is inserted, and including a second contact against which the second counterpart terminal abuts,

wherein a first dimension from the other opening of the first body to the first contact is shorter than a second dimension from the other opening of the second body to the second contact.

The first contact plate may extend in a direction parallel to a direction in which the second contact plate extends, and

the other opening of the first body and the other opening of the second body may be provided on a plane orthogonal to the direction in which the first contact plate extends.

The first contact may be provided at an end of the first contact plate.

The first terminal may further include:

an arched contact plate protruding toward the first contact plate in an arch shape and facing the first contact plate, and

the first contact plate may have a shape such that the end of the first contact plate curves toward the arched contact plate and then bends to a side opposite to a curving side.

The first contact plate and the first body may be formed of a single member.

The first contact plate may be formed of a member different from a member forming the first body.

The connector may include a housing that includes a first-terminal housing chamber that houses the first terminal and a second-terminal housing chamber that houses the second terminal, the housing being formed of an electrical insulating material.

A connector unit according to a second aspect of the present disclosure includes:

the connector according to the first aspect; and

a counterpart connector including the first counterpart terminal and the second counterpart terminal that are formed of an electrically conductive material, the counterpart connector being mated to the connector,

wherein the connector unit is configured so that the first counterpart terminal abuts against the first contact and then the second counterpart terminal abuts against the second contact when the connector and the counterpart connector are becoming mated together.

The counterpart connector may include a counterpart housing that is formed of an electrical insulating material and that supports the first counterpart terminal and the second counterpart terminal that are protruding, and

a value obtained by subtracting a length of a protruding portion of the first counterpart terminal from a length of a protruding portion of the second counterpart terminal may be shorter than a value obtained by subtracting the first dimension from the second dimension.

The connector according to the present disclosure can include the FMLB structure without increasing the total length of a first terminal, by making a first dimension for the first terminal shorter than a second dimension for a second terminal and by causing the first terminal to function as a ground terminal. As a result, the connector and the connector unit can be prevented from being larger while the FMLB structure is included.

### BRIEF DESCRIPTION OF THE DRAWINGS

A more complete understanding of this application can be obtained when the following detailed description is considered in conjunction with the following drawings, in which:

FIG. 1 is an exploded perspective view of a connector unit according to an embodiment of the present disclosure;

FIG. 2 is an exploded plan view of the connector unit;

FIG. 3 is a cross-sectional view taken along in FIG. 2;

FIG. 4A is a front view of a connector;

FIG. 4B is a front view of the connector, intended to explain an arrangement of ground terminals and signal terminals in the housing;

FIG. 5A is a perspective view of a ground terminal;

FIG. 5B is a cross-sectional view of the ground terminal;

FIG. 6A is a front view of the ground terminal;

FIG. 6B is an enlarged cross-sectional view of the end of the ground terminal;

FIG. 7 is a perspective view depicting a cross-section taken along VII-VII in FIG. 6;

FIG. 8A is a cross-sectional view of a resilient contact plate of the ground terminal;

FIG. 8B is a perspective view of the ground terminal in which the top plate of the body is partially omitted;

FIG. 9A is a figure (part 1) intended to explain producing the resilient contact plate of the ground terminal;

FIG. 9B is a figure (part 2) intended to explain producing the resilient contact plate of the ground terminal;

FIG. 10A is a cross-sectional view of a signal terminal;

FIG. 10B is an enlarged cross-sectional view of the end of the signal terminal;

FIG. 10C is a cross-sectional view intended to explain an arrangement of the ground terminal and the signal terminal in the housing;

FIG. 11A is a cross-sectional view (part 1) intended to explain mating connectors together;

FIG. 11B is an enlarged cross-sectional view (part 1) of the end of the ground terminal, intended to explain mating connectors together;

FIG. 11C is an enlarged cross-sectional view (part 1) of the end of the signal terminal, intended to explain mating connectors together;

FIG. 12A is a cross-sectional view (part 2) intended to explain mating connectors together;

FIG. 12B is an enlarged cross-sectional view (part 2) of the end of the ground terminal, intended to explain mating connectors together;

FIG. 12C is an enlarged cross-sectional view (part 2) of the end of the signal terminal, intended to explain mating connectors together;

FIG. 13 is a cross-sectional view (part 3) intended to explain mating connectors together;

FIG. 14 is a cross-sectional view (part 4) intended to explain mating connectors together;

FIG. 15 is a cross-sectional view (part 1) intended to explain unmating connectors from each other;

FIG. 16 is a cross-sectional view (part 2) intended to explain unmating connectors from each other;

FIG. 17A is a cross-sectional view (part 3) intended to explain unmating connectors from each other;

FIG. 17B is an enlarged cross-sectional view (part 1) of the end of the ground terminal, intended to explain unmating connectors from each other;

FIG. 17C is an enlarged cross-sectional view (part 1) of the end of the signal terminal, intended to explain unmating connectors from each other;

FIG. 18A is a cross-sectional view (part 4) intended to explain unmating connectors from each other;

FIG. 18B is an enlarged cross-sectional view (part 2) of the end of the ground terminal, intended to explain unmating connectors from each other;

FIG. 18C is an enlarged cross-sectional view (part 2) of the end of the signal terminal, intended to explain unmating connectors from each other;

FIG. 19 is a cross-sectional view intended to explain an effect of the connector; and

FIG. 20 is an exploded cross-sectional view of a connector unit according to a variation.

### DETAILED DESCRIPTION

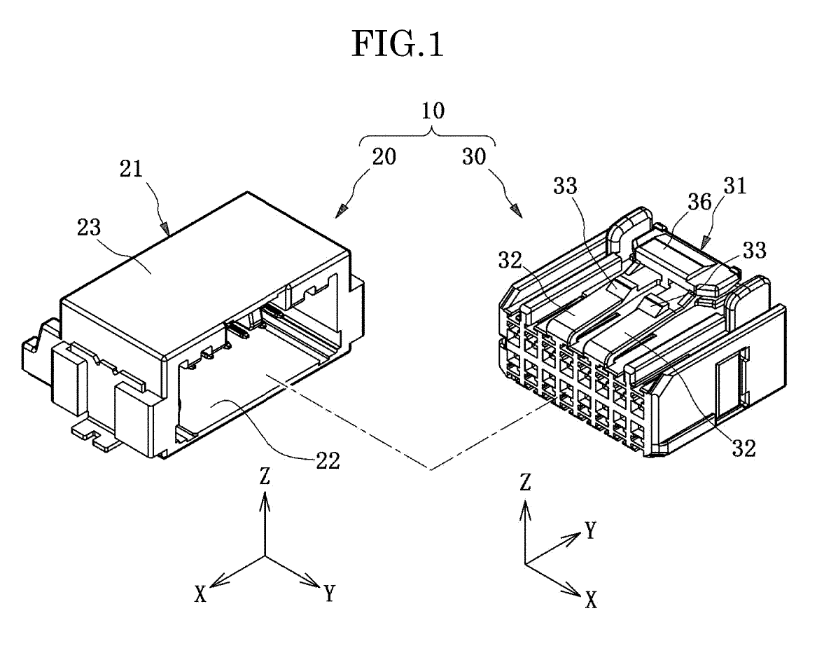

A connector unit 10 and a connector 30 according to an embodiment of the present disclosure will now be described with reference to FIGS. 1 to 20. For ease of understanding, XYZ coordinates are applied to the figures and referred to as appropriate. In the present embodiment, the Y-axis direction is parallel to the mating direction D1, along which the connector 30 is moved toward a counterpart connector 20 to be mated together. An X-Z plane is orthogonal to the mating direction D1.

The connector unit 10 may be used, for example, for connection between electronic circuit components installed in a car. As illustrated in FIG. 1, the connector unit 10 includes the counterpart connector 20 and the connector 30.

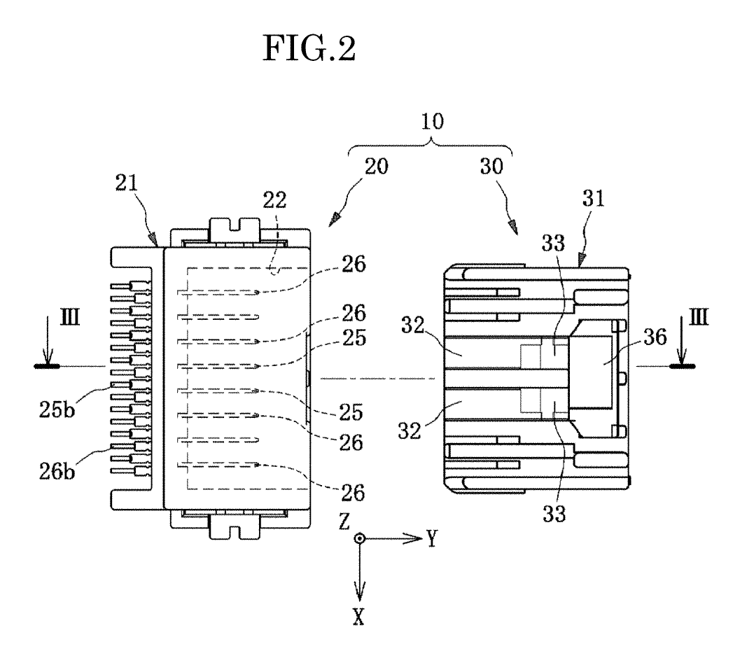

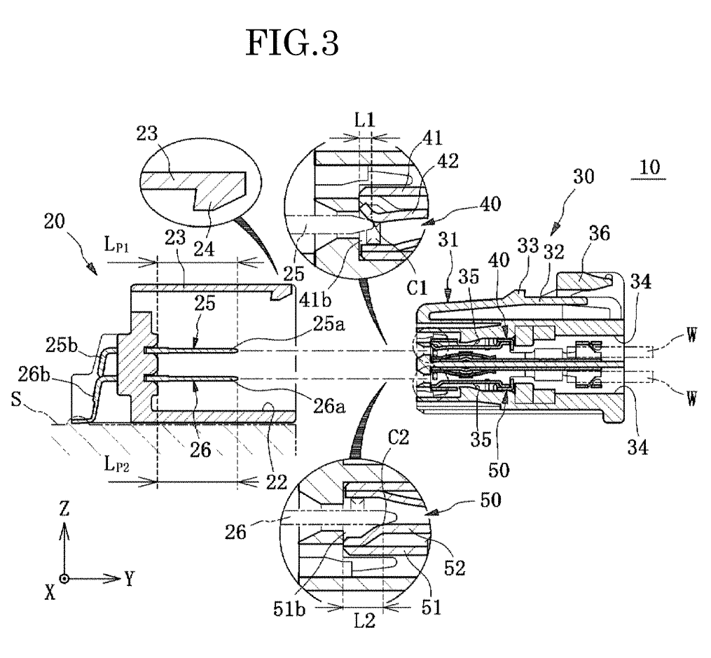

The counterpart connector 20 is mated to the connector 30. In the present embodiment, the counterpart connector 20 includes a male connector. As illustrated in FIGS. 2 and 3, the counterpart connector 20 includes a counterpart housing 21 formed of an electrical insulating material, two counterpart ground terminals 25 (first counterpart terminals), and fourteen counterpart signal terminals 26 (second counterpart terminals).

The counterpart housing 21 is a member in a substantially box shape with a mating hole 22 having an opening on the +Y side. Into the mating hole 22 in the counterpart housing 21, the connector 30 is to be inserted. An engaging part 24 is formed near a ceiling wall 23 of the counterpart housing 21 on the +Y side. As illustrated in FIG. 3, on the engaging part 24, a sloping face that is inclined with respect to the Y-axis direction and an engaging face that is approximately parallel to a plane orthogonal to the Y-axis direction are formed.

The counterpart ground terminal 25 and the counterpart signal terminal 26 each are formed of an electrically conductive material. The counterpart ground terminal 25 and the counterpart signal terminal 26 each include a male terminal. In the present embodiment, the counterpart ground terminal 25 and the counterpart signal terminal 26 are formed in an identical size and an identical shape. At the ends of the counterpart ground terminal 25 and the counterpart signal terminal 26, ends 25a and 26a are formed on the +Y side, while ends 25b and 26b are formed on the −Y side, protruding from the counterpart housing 21. The ends 25a and 26a on the +Y side protrude in a space inside the counterpart housing 21. The length LP1 of a protruding portion of the counterpart ground terminal 25 is equal to the length LP2 of a protruding portion of the counterpart signal terminal 26. The ends 25b and 26b on the −Y side are formed to be exposed from the rear end face of the counterpart housing 21 on the −Y side, be bent in a substantially S shape, and protrude in parallel with the −Y direction. The ends 25b and 26b are used as external leads soldered to a wiring substrate S.

As illustrated in FIG. 3, a wire W is connected to the connector 30 in the present embodiment. The connector 30 includes a housing 31 made from a resin, two ground terminals 40 (first terminals), and fourteen signal terminals 50 (second terminals). The connector 30 of the present embodiment includes ground terminals 40 for grounding and signal terminals 50 for signal transmission. However, this is not the only option. The connector 30 may only include signal terminals 50 without ground terminals 40, or may include terminals for other uses such as electric power supply.

The housing 31 is formed into a substantially rectangular-cuboid shape whose longitudinal direction corresponds to the Y-axis direction. In the housing 31, an arm 32, an engaged part 33 disposed on the arm 32, insertion slots 34 into which the ground terminals 40 and the signal terminals 50 are inserted, and a disengaging part 36 are formed.

The arm 32 is disposed so as to extend along the Y-axis direction, which corresponds to the longitudinal direction of the housing 31, and to protrude in the +Z direction. The arm 32 is disposed so as to deform when the connector 30 and the counterpart connector 20 are becoming mated together.

The engaged part 33, which is the counterpart of the engaging part 24, is engaged by the engaging part 24 when the counterpart connector 20 and the connector 30 are mated together. On the engaged part 33, a sloping face inclined by an angle equal to that of the sloping face on the engaging part 24, a flat face approximately parallel to an X-Y plane, and a engaged face approximately parallel to an X-Z plane are formed.

The insertion slot 34 is formed on the rear end face (the end face on the +Y side) of the housing 31. The insertion slot 34 is formed at sixteen points corresponding to the total number of ground terminals 40 and signal terminals 50. Each insertion slot 34 is led to one of a plurality of terminal housing chambers 35 that are formed inside of the housing 31.

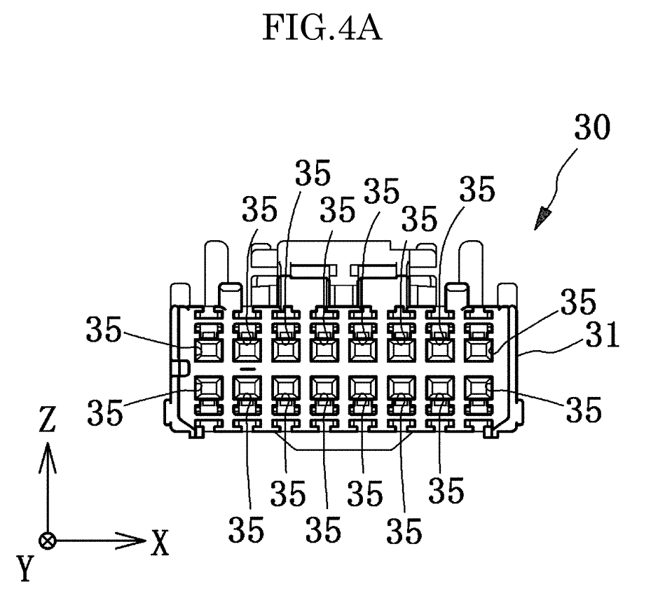

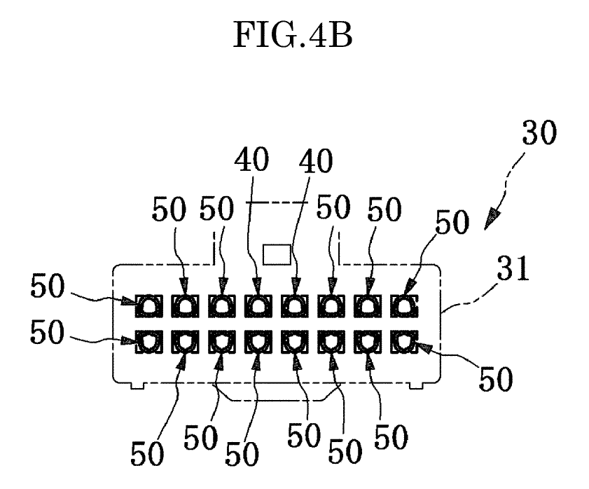

As illustrated in FIGS. 4A and 4B, which are front views of the housing 31 seen from its front end, sixteen terminal housing chambers 35 in two rows by eight columns are formed in the housing 31. These sixteen terminal housing chambers 35 are all formed in an identical size and an identical shape. The ground terminals 40 are housed in two terminal housing chambers 35 (first-terminal housing chambers) that are located around the center of the upper row. The signal terminals 50 are housed in the other terminal housing chambers 35 (second-terminal housing chambers). The signal terminals 50 housed in the lower terminal housing chambers 35 are disposed so as to be upside down relative to the ground terminals 40 and signal terminals 50 housed in the upper terminal housing chambers 35. Specifically, the signal terminals 50 housed in the lower row are installed into the terminal housing chambers 35 so that the bottom plate of the body 51, which is described below, of the signal terminal 50 housed in the lower row is opposed to the bottom plate 41-2 of the body 41, which is described below, of the ground terminal 40 housed in the upper row, or to the bottom plate of the body 51 of the signal terminal 50 housed in the upper row.

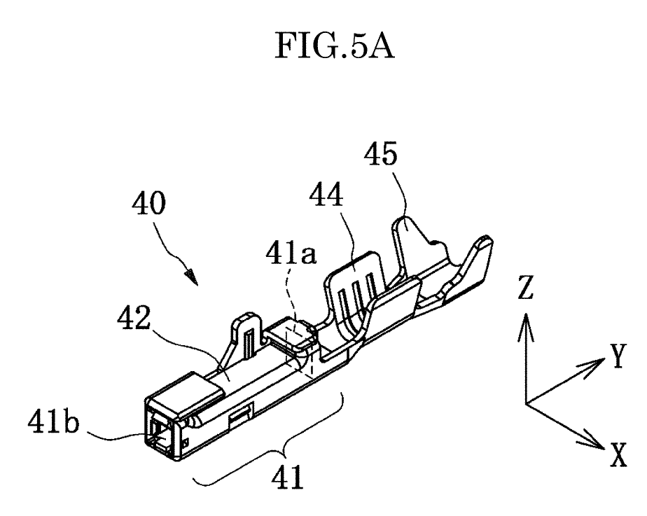

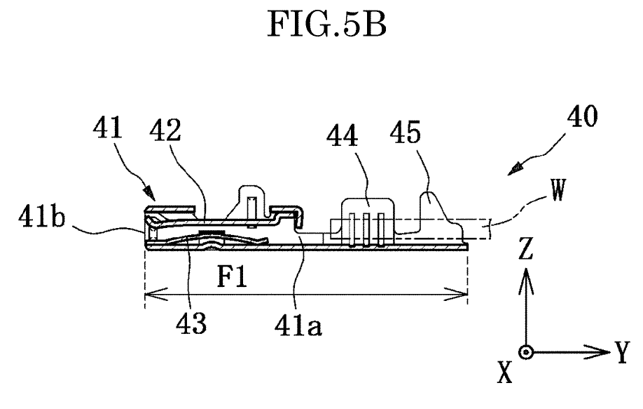

The ground terminal 40 is formed by bending an electrically conductive plate material made from copper, a copper alloy, or the like. As illustrated in FIGS. 5A and 5B, the ground terminal 40 includes a female terminal. The ground terminal 40 includes the body 41 (first body), a resilient contact plate 42 (first contact plate), an arched contact plate 43, a conductor swaging part 44, and an insulator holding part 45. In the present embodiment, the body 41, the resilient contact plate 42, the conductor swaging part 44, and the insulator holding part 45 are formed by bending a single plate material, while the arched contact plate 43 is formed by bending another single plate material.

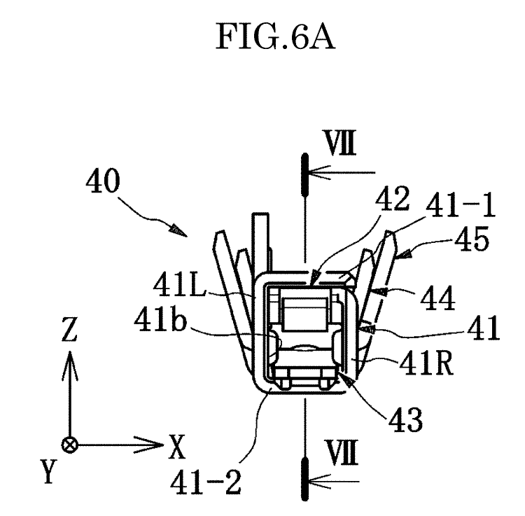

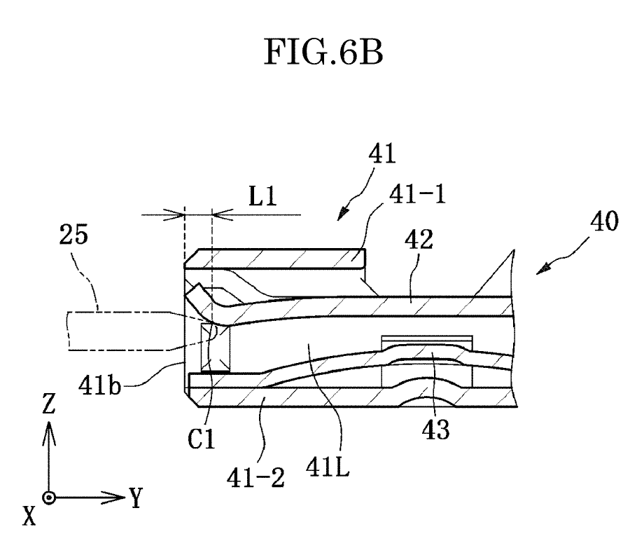

As illustrated in FIGS. 5B and 6A, the body 41 is formed into a substantially rectangular tube having two openings: an opening 41a on the +Y side (one opening of the first body) and an opening 41b on the −Y side (an other opening of the first body), the body 41 including a top plate 41-1, a bottom plate 41-2, and a pair of side plates 41R and 41L. As illustrated in FIG. 6B, the opening 41b on the −Y side is formed to be an opening through which the counterpart ground terminal 25 is inserted.

As illustrated in FIG. 6B, the resilient contact plate 42 is supported inside the body 41, facing the top plate 41-1 of the body 41. The resilient contact plate 42 extends in the −Y direction from the opening 41a toward the opening 41b of the body 41.

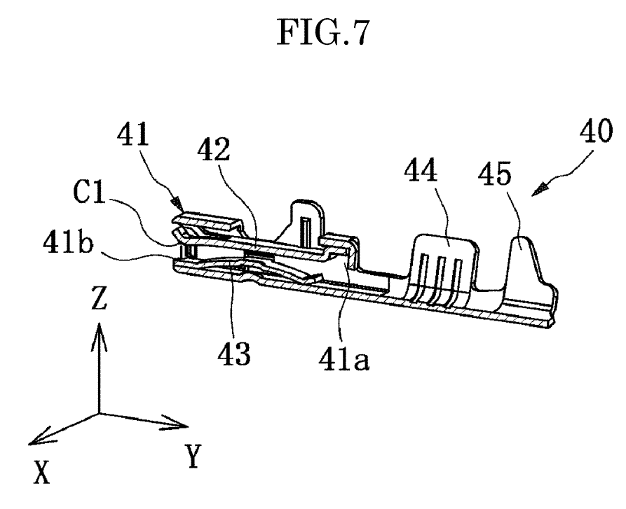

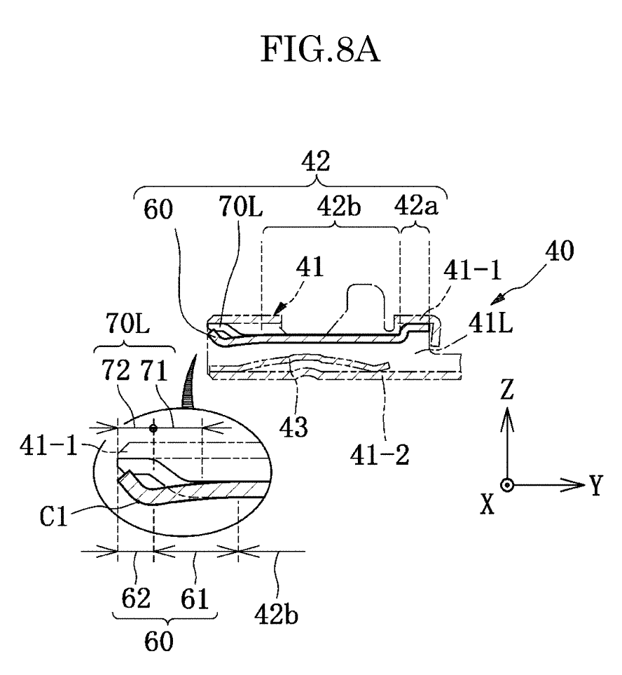

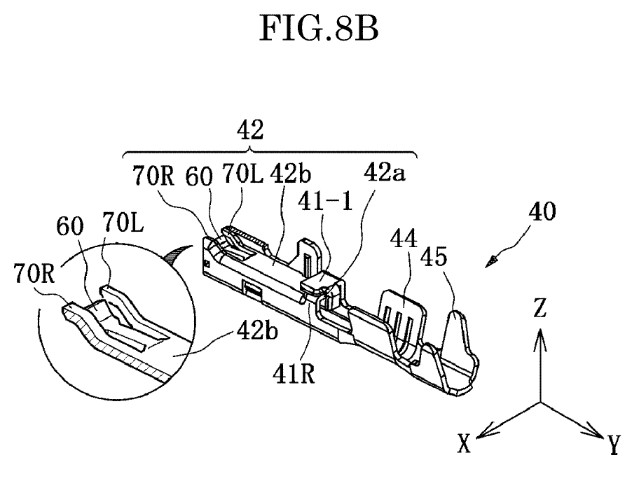

Specifically, as illustrated in FIGS. 7, 8A, and 8B, the resilient contact plate 42 includes a base 42a, a contact plate body 42b, a middle end 60, a pair of side ends 70R and 70L, and a contact C1 (first contact) that will abut against the counterpart ground terminal 25. Note that the top plate 41-1 is partially omitted in FIG. 8B for ease of understanding.

As illustrated in FIGS. 8A and 8B, the base 42a extends from the side plate 41R of the body 41 and is positioned below the lower face (the face on the −Z side) of the top plate 41-1. The base 42a is formed into a plate having a face parallel to an X-Y plane.

The contact plate body 42b extends from the base 42a in the −Y direction. The contact plate body 42b is formed into a plate having a face parallel to an X-Y plane, being offset downward from the base 42a. From the contact plate body 42b, the middle end 60 and the pair of side ends 70R and 70L are extended.

The middle end 60 includes a first extension 61 curving downward and a second extension 62 extending downward and then bending upward. On the lower face of the second extension 62 is disposed the contact C1, which is an area to abut against the counterpart ground terminal 25.

The side ends 70R and 70L are formed on the sides of the middle end 60. The side end 70L includes a sloping part 71 inclined with respect to an X-Y plane and a parallel part 72 parallel to an X-Y plane. The parallel part 72 is positioned below the lower face (the face on the −Z side) of the top plate 41-1. Likewise, the side end 70R includes a sloping part inclined with respect to an X-Y plane and a parallel part parallel to an X-Y plane. The parallel part of the side end 70R is positioned below the lower face (the face on the −Z side) of the top plate 41-1. The side end 70L and the side end 70R are in a symmetrical form with respect to a Y-Z plane.

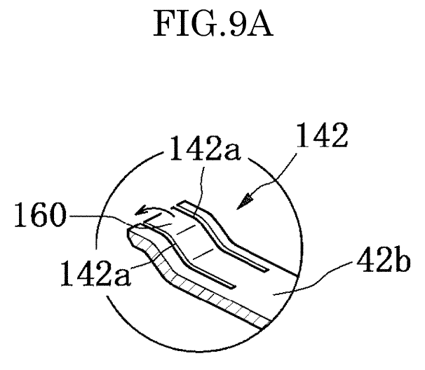

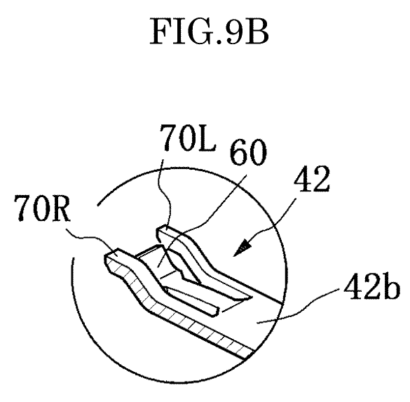

The resilient contact plate 42 as configured above is produced by, for example, using a method illustrated in FIG. 9.

The operator producing the resilient contact plate 42 starts with preparing a contact plate 142 where the middle end 60 is not made yet, as illustrated in FIG. 9A. In terms of size and shape, the contact plate 142 is the same as a contact plate 52, which is described below, of the signal terminal 50. Next, the operator makes a cut 142a in the contact plate 142. The side ends 70R and 70L are now formed. Then, the operator bends the end 160 in the middle to form the middle end 60 as illustrated in FIG. 9B. In this way, the resilient contact plate 42 with the middle end 60 is completed.

By modifying the contact plate 142, which is equivalent to the contact plate 52 of the signal terminal 50, the resilient contact plate 42 with the middle end 60 can be easily obtained. Thus, terminals in a conventional shape can be reused and the cost of producing the connector 30 can be reduced.

FIG. 9 shows that the middle end 60 is formed after the side ends 70R and 70L are formed, but these parts may be formed in a different order. As long as the resilient contact plate 42 can be formed, the side ends 70R and 70L and the middle end 60 may be formed simultaneously after a cut 142a is made in the flat contact plate 142. Any other method may also be used.

As illustrated in FIG. 5, the arched contact plate 43, which is a plate spring member having resilience, presses in the +Z direction the counterpart ground terminal 25 inserted into the body 41 and makes electrical contact with the counterpart ground terminal 25. The arched contact plate 43 is supported inside the body 41 so as to lie on the bottom plate of the body 41. The arched contact plate 43 extends from the opening 41b toward the opening 41a of the body 41. The arched contact plate 43 faces the resilient contact plate 42, protruding toward the resilient contact plate 42 in the form of an arch.

The conductor swaging part 44 and the insulator holding part 45 together form a wire swaging part intended to swage the wire W. The conductor swaging part 44 is crimped onto through swaging, and makes electrical contact with, the tip of a core in the electrically insulated wire W. The insulator holding part 45 presses an end part of the electrically insulated wire W through swaging to protect the connection between the conductor swaging part 44 and the core from pullout force. The conductor swaging part 44 and the insulator holding part 45 are formed integrally with the body 41. As a result, the core crimped on the conductor swaging part 44 comes into electrical contact with the counterpart ground terminal 25 that has been inserted into the body 41.

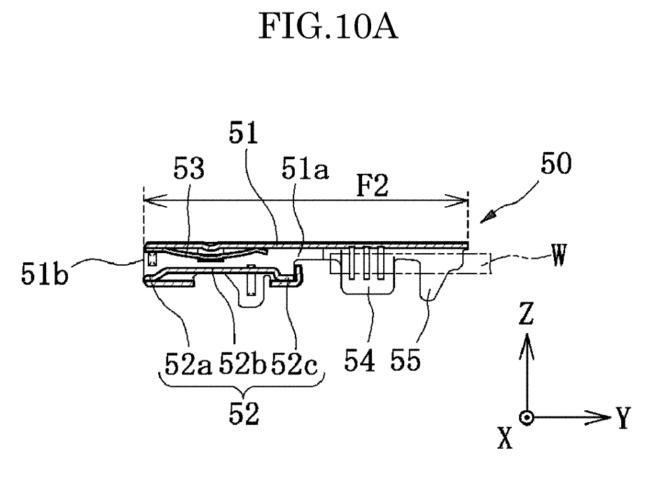

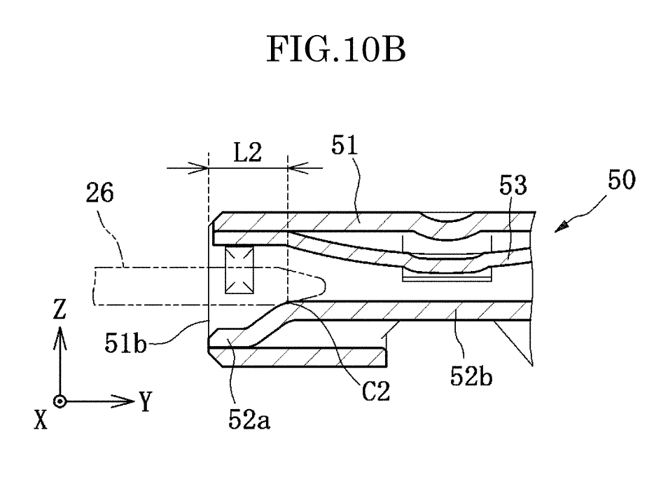

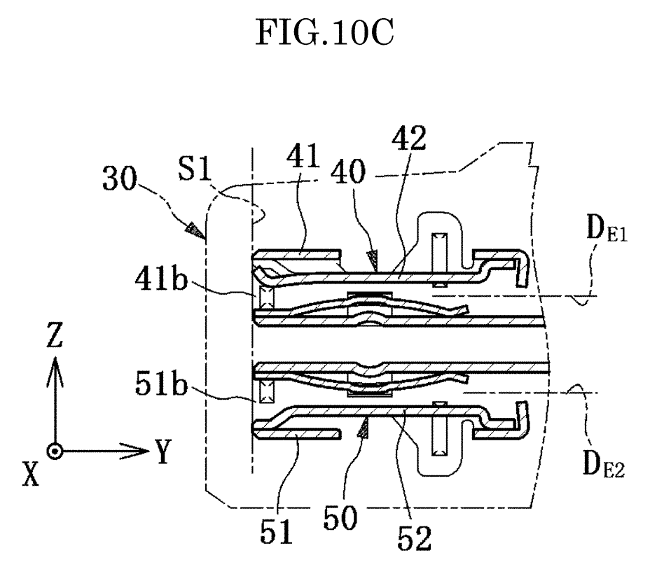

As illustrated in FIGS. 10A and 10B, in the present embodiment, the signal terminal 50 differs from the ground terminal 40 in the shape of the end of the resilient contact plate 42. The signal terminal 50 is formed by bending an electrically conductive plate material made from copper, a copper alloy, or the like. As with the ground terminal 40, the signal terminal 50 includes a female terminal. The signal terminal 50 includes a body 51 (second body), a contact plate 52 (second contact plate), an arched contact plate 53, a conductor swaging part 54, and an insulator holding part 55. In the present embodiment, the body 51, the contact plate 52, the conductor swaging part 54, and the insulator holding part 55 are formed by bending a single plate material, while the arched contact plate 53 is formed by bending another single plate material.

The body 51 is a member equivalent to the body 41 of the ground terminal 40. The body 51 is formed into a substantially rectangular tube having two openings: an opening 51a on the +Y side (one opening of the second body) and an opening 51b on the −Y side (an another opening of the second body), the body 51 including a top plate, a bottom plate, and a pair of side plates. The opening 51b on the −Y side is formed to be an opening through which the counterpart signal terminal 26 is inserted. As illustrated in FIG. 10C, the opening 51b is provided on a plane S1 orthogonal to the Y-axis direction, along with the opening 41b in the body 41 of the ground terminal 40.

As illustrated in FIGS. 10A and 10B, the contact plate 52 includes a first plate 52a and a third plate 52c that is positioned on the top plate of the body 51, as well as including a second plate 52b that is disposed away from the top plate of the body 51. The contact plate 52 is supported inside the body 51. The contact plate 52 extends from the opening 51a toward the opening 51b of the body 51, sequentially forming the third plate 52c, the second plate 52b, and the first plate 52a. Note that, as illustrated in FIG. 10C, the extending direction DE2 for the contact plate 52 is parallel to the Y-axis direction, and is also parallel to the extending direction DE1 for the resilient contact plate 42 in the ground terminal 40. As seen in FIG. 10B, the contact plate 52 includes a contact C2 (second contact), which is to abut against the counterpart signal terminal 26 inserted through the opening 51b of the body 51. The contact C2 is provided at the end of the contact plate 52.

As illustrated in FIGS. 10A and 10B, the arched contact plate 53 is a member equivalent to the arched contact plate 43 in the ground terminal 40. The arched contact plate 53, which is a plate spring member having resilience, presses in the −Z direction the counterpart signal terminal 26 inserted into the body 51 and makes electrical contact with the counterpart signal terminal 26. The arched contact plate 53 is supported inside the body 51 so as to lie on the bottom plate of the body 51. The arched contact plate 53 extends from the opening 51b toward the opening 51a of the body 51. The arched contact plate 53 faces the contact plate 52, protruding toward the contact plate 52 in the form of an arch.

The conductor swaging part 54 and the insulator holding part 55 together form a wire swaging part intended to swage the wire W. The conductor swaging part 54 and the insulator holding part 55 are members equivalent to the conductor swaging part 44 and the insulator holding part 45, respectively, of the ground terminal 40.

Referring to FIGS. 6B and 10B, it is seen that the dimension L1 (first dimension) between the opening 41b and the contact C1 in the body 41 is shorter than the dimension L2 (second dimension) between the opening 51b and the contact C2 in the body 51. Referring to FIGS. 5B and 10A, it is seen that the total length F1 of the ground terminal 40 is equal to the total length F2 of the signal terminal 50. However, the lengths may not necessarily be identical, and the total length F1 of the ground terminal 40 may be approximately equal to the total length F2 of the signal terminal 50.

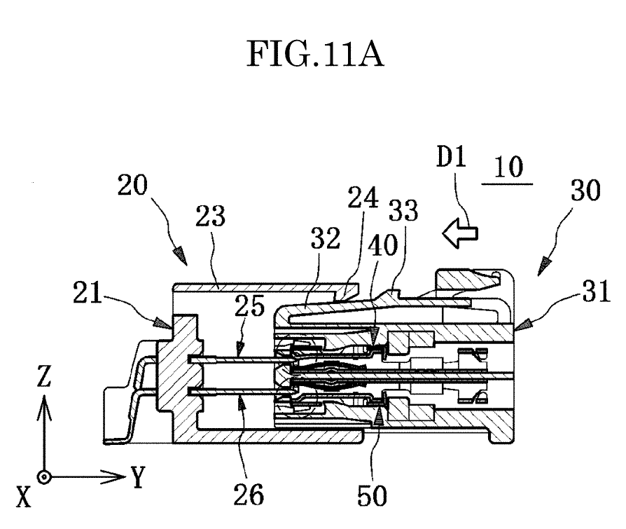

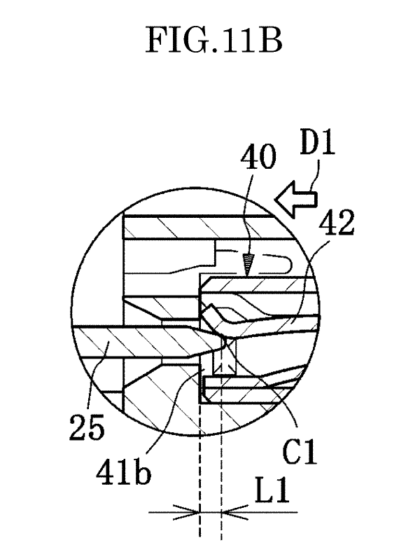

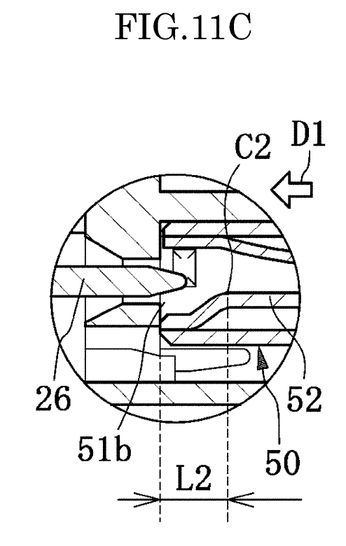

The following describes how the counterpart connector 20 and the connector 30 in the connector unit 10 configured as above are mated together, referring to FIGS. 11 to 14.

When the connector 30 is moved in the mating direction D1 as depicted in FIG. 11A, the contact C1 on the resilient contact plate 42 of the ground terminal 40 first abuts against the counterpart ground terminal 25 as illustrated in FIG. 11B, due to the fact that the dimension L1 for the ground terminal 40 is shorter than the dimension L2 for the signal terminal 50. As a result, the ground terminal 40 comes into electrical contact with the counterpart ground terminal 25. At this point of time, the counterpart signal terminal 26 is out of contact with the contact plate 52 of the signal terminal 50, and thus no electrical connection is established between the counterpart signal terminal 26 and the signal terminal 50, as illustrated in FIG. 11C.

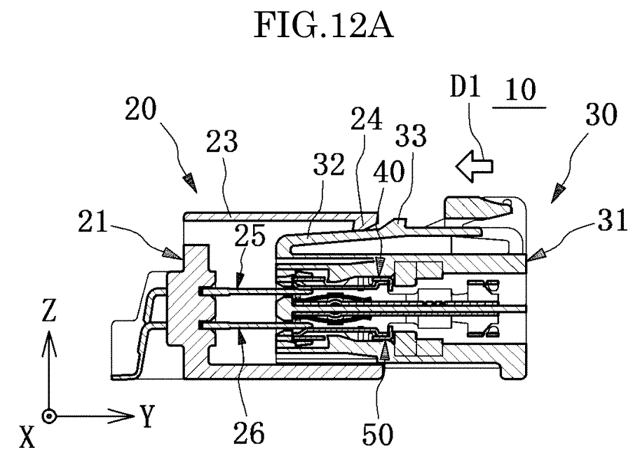

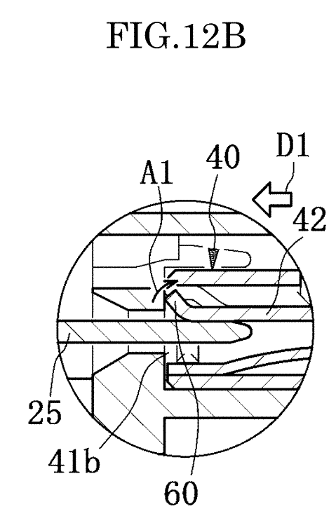

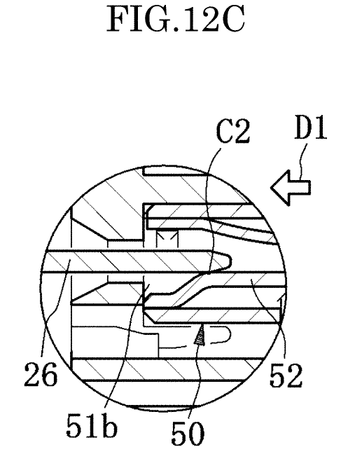

When the connector 30 is further moved in the mating direction D1 as depicted in FIG. 12A, the middle end 60 of the resilient contact plate 42 deforms in the deforming direction A1 as indicated in FIG. 12B. Then, while the conduction state is maintained due to the contact between the counterpart ground terminal 25 and the resilient contact plate 42 of the ground terminal 40, the counterpart ground terminal 25 is getting inserted into the ground terminal 40. At this point of time, as illustrated in FIG. 12C, the contact C2 on the contact plate 52 of the signal terminal 50 abuts against the counterpart signal terminal 26. As a result, the signal terminal 50 comes into electrical contact with the counterpart signal terminal 26.

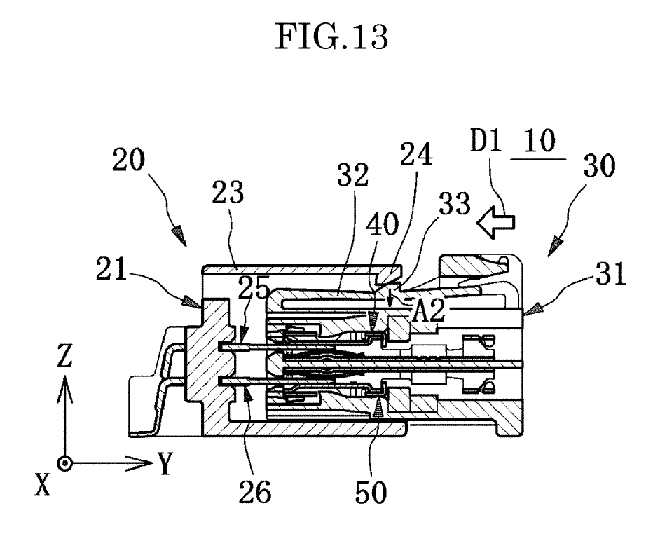

When the connector 30 is further moved in the mating direction D1 as depicted in FIG. 13, the engaged part 33 in the housing 31 comes into contact with the engaging part 24 in the counterpart housing 21. Then, the engaged part 33 is guided to the sloping face on the engaging part 24, which causes the arm 32 to sag, and accordingly, the engaged part 33 is pressed downward (to the −Z side) as indicated by an arrow A2.

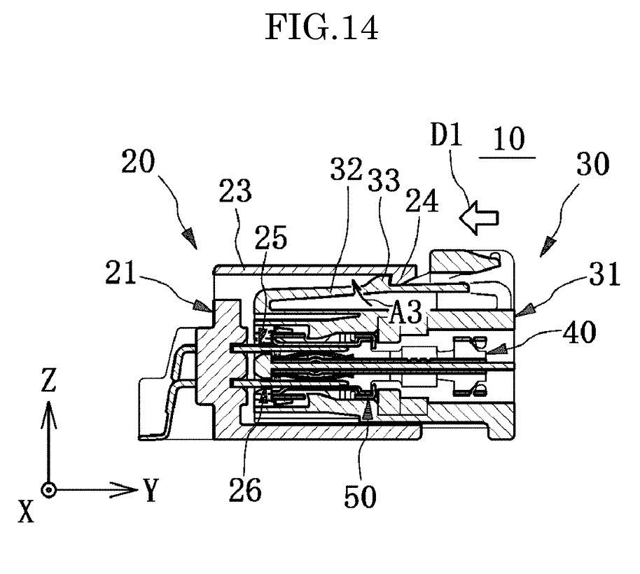

When the connector 30 is still further moved in the fitting direction D1 as depicted in FIG. 14, the arm 32 recovers from sagging due to its resilience, and accordingly the engaged part 33 is caused to return upward (to the +Z side), as indicated by an arrow A3. As a result, the engaging face of the engaging part 24 faces the engaged face of the engaged part 33, and the engaging part 24 engages the engaged part 33. The connector 30 and the counterpart connector 20 in the connector unit 10 are now completely mated together.

The following describes how the counterpart connector 20 and the connector 30 in the connector unit 10 are unmated, referring to FIGS. 15 to 18 and FIG. 3.

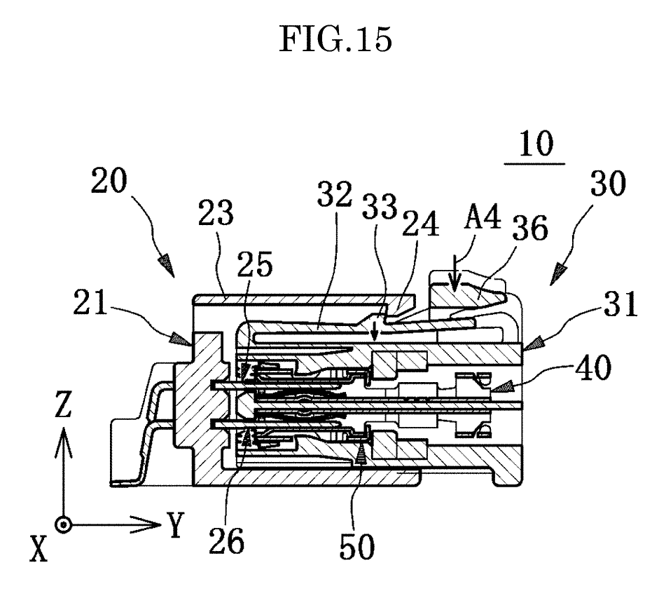

To unmate the counterpart connector 20 and the connector 30 from each other, first, the disengaging part 36 in the connector 30 is pressed downward as indicated by an arrow A4 in FIG. 15. Then, the arm 32 is caused to sag, which causes the engaged part 33 to be pressed downward (to the −Z side). As a result, the engaging part 24 unengages the engaged part 33.

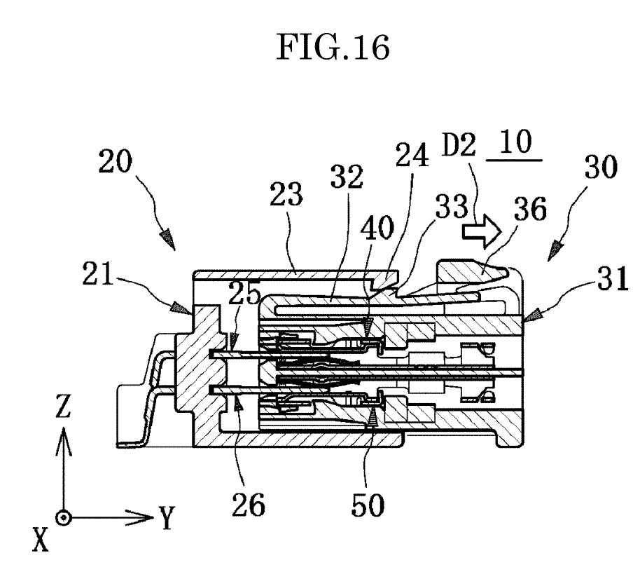

Then, as illustrated in FIG. 16, while the disengaging part 36 remains pressed, the connector 30 is moved in the removing direction D2 to be pulled out of the counterpart connector 20.

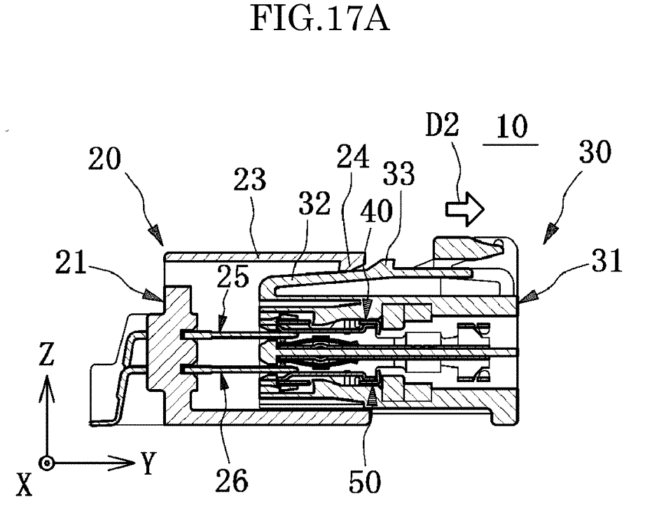

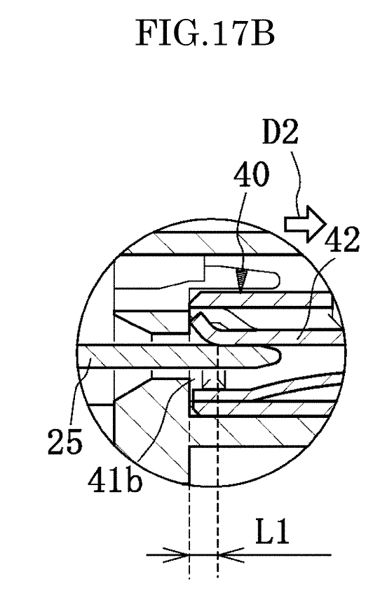

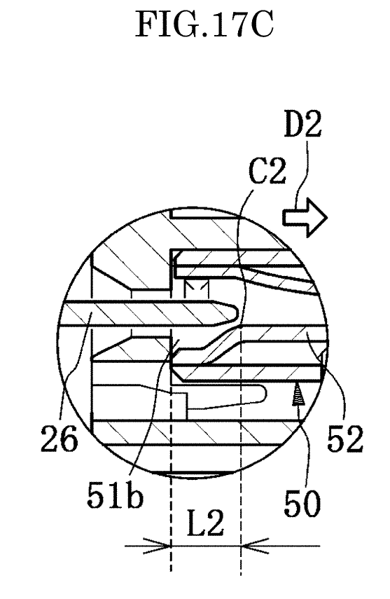

When the connector 30 is further moved in the removing direction D2 as depicted in FIG. 17A, the contact plate 52 of the signal terminal 50 is first withdrawn from the counterpart signal terminal 26 as illustrated in FIG. 17C, due to the fact that the dimension L2 for the signal terminal 50 is longer than the dimension L1 for the ground terminal 40. As a result, the signal terminal 50 becomes electrically disconnected from the counterpart signal terminal 26. At this point of time, as illustrated in FIG. 17B, the resilient contact plate 42 of the ground terminal 40 still lies on the counterpart ground terminal 25, and thus the conduction state is maintained.

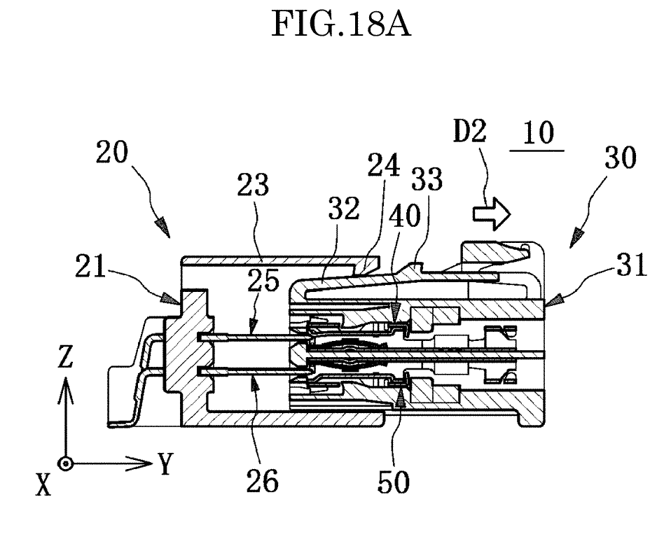

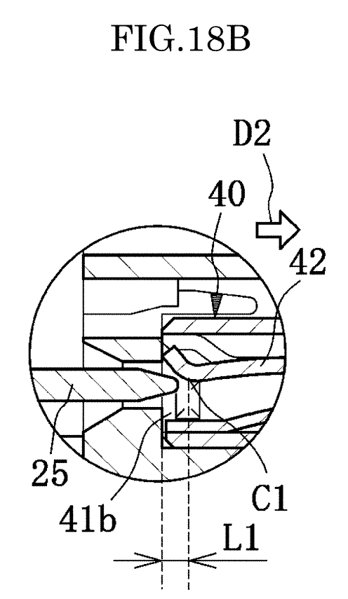

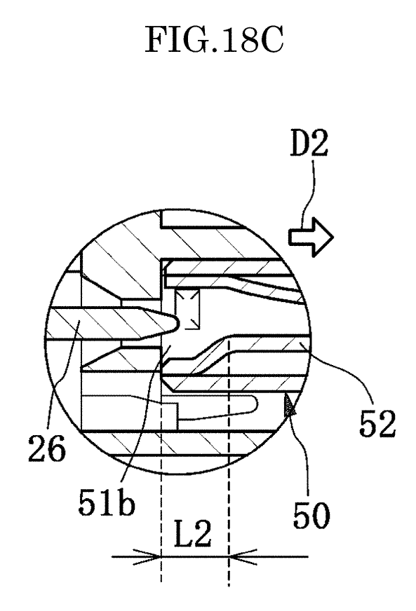

When the connector 30 is further moved in the removing direction D2 as depicted in FIG. 18A, the resilient contact plate 42 of the ground terminal 40 is withdrawn from the counterpart ground terminal 25 as illustrated in FIG. 18B. As a result, the ground terminal 40 becomes electrically disconnected from the counterpart ground terminal 25. At this point of time, the signal terminal 50 has already been electrically disconnected from the counterpart signal terminal 26 as illustrated in FIG. 18C, and thus both the ground terminal 40 and the signal terminal 50 are now electrically disconnected.

When the connector 30 is further moved in the removing direction D2, the connector 30 is removed from the counterpart connector 20 as in FIG. 3. The connector 30 and the counterpart connector 20 in the connector unit 10 are now unmated.

As described above, in the present embodiment, the dimension L1 in the inside of the ground terminal 40 is shorter than the dimension L2 in the inside of the signal terminal 50, which is illustrated in FIG. 3. Hence, the FMLB structure can be included without increasing the total length F1 of the ground terminal 40. This eliminates the need for a larger housing 31 to accommodate an increased total length F1 of the ground terminal 40. As a result, the connector 30 and the connector unit 10 can be prevented from being larger while the FMLB structure is included. The connector 30 and the connector unit 10 can even be made smaller by using the structure of the present embodiment.

Additionally, in the present embodiment, the length LP1 of a protruding portion of the counterpart ground terminal 25 is equal to the length LP2 of a protruding portion of the counterpart signal terminal 26. This eliminates the need for a larger counterpart housing 21 to accommodate the length LP1 or LP2 of a protruding portion. As a result, the counterpart connector 20 can be prevented from being larger.

In the connector unit 10 according to the present embodiment, while both the connector 30 and the connector unit 10 are prevented from being larger, the ground terminal 40 is allowed to contact the counterpart ground terminal 25 before the signal terminal 50 comes into contact with the counterpart signal terminal 26, when the connector 30 and the counterpart connector 20 are becoming mated together. In addition, while both the connector 30 and the connector unit 10 are prevented from being larger, the ground terminal 40 is allowed to withdraw from the counterpart ground terminal 25 after the signal terminal 50 is separated from the counterpart signal terminal 26, when the connector 30 and the counterpart connector 20 are becoming unmated. As a result, the wiring substrate S connected to the counterpart connector 20 and a semiconductor or electronic component connected to the wire W can be protected from an excessive electric stress.

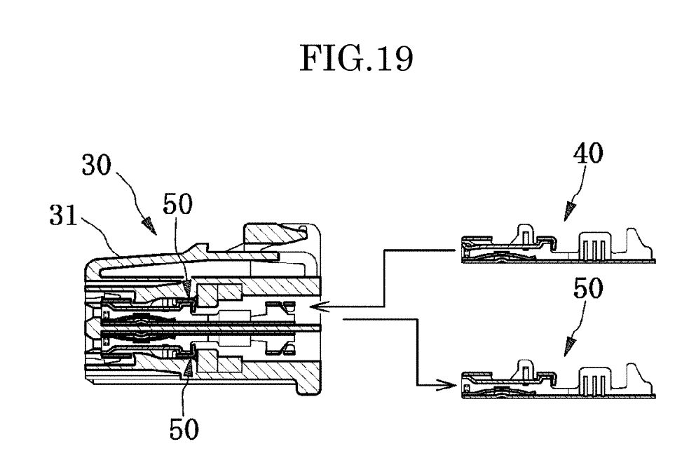

In the present embodiment, the ground terminal 40 and the signal terminal 50 are formed into an identical shape, except the ends of the resilient contact plate 42 and the contact plate 52. Therefore, the connector 30 with the FMLB structure can be produced from, for example, the connector 30 without the FMLB structure as illustrated in FIG. 19, by removing the signal terminal 50 from the housing 31 and then installing the ground terminal 40. In this case, no design change is needed for the housing 31, thereby achieving a lower cost of the connector 30. In addition, operations including removing the ground terminal 40 and installing the signal terminal 50, or removing the signal terminal 50 and installing the ground terminal 40 can be performed easily. Furthermore, the ground terminal 40 and others according to the present embodiment can be applied to a housing 31 for an existing connector 30, and thus the versatility of the connector 30 can be increased.

In the present embodiment, the ground terminal 40 includes the resilient contact plate 42 having the contact C1 provided at the end on the −Y side. The ground terminal 40 and the signal terminal 50 are formed into the same shape except the end of the resilient contact plate 42, and thus the connector 30 with the FMLB structure can be achieved merely by making a minor modification to the signal terminal 50.

Embodiments of the present disclosure have been described above, but the present disclosure is not limited to the foregoing embodiments.

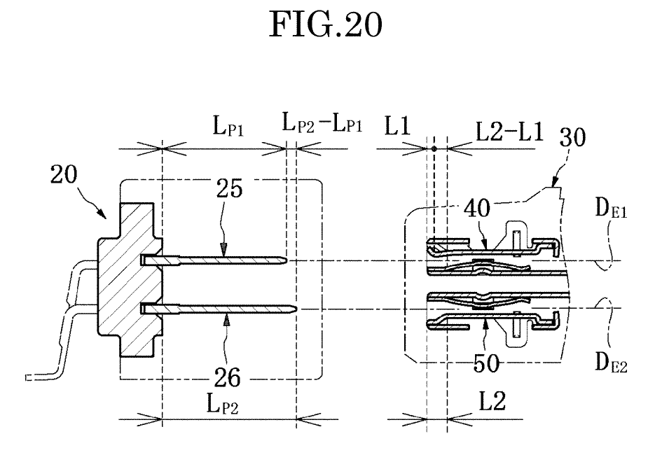

For example, in the embodiment according to the present disclosure, the length LP1 of a protruding portion of the counterpart ground terminal 25 is equal to the length LP2 of a protruding portion of the counterpart signal terminal 26 as indicated in FIG. 3. However, the lengths may not necessarily be equal. As illustrated in FIG. 20, the length LP1 may be different from the length LP2, as long as the difference (LP2−LP1) obtained by subtracting LP1 from LP2, where LP1 is the length of a protruding portion of the counterpart ground terminal 25 and LP2 is the length of a protruding portion of the counterpart signal terminal 26, is less than the difference (L2−L1) obtained by subtracting the dimension L1 from the dimension, that is, L2 {(LP2−LP1)<(L2−L1)}. For example, contrary to the structure of a conventional connector (that is, the connector described in Patent Literature 1), the length LP2 of a protruding portion of the counterpart signal terminal 26 may be longer than the length LP1 of a protruding portion of the counterpart ground terminal 25. In this case, as long as the difference (LP2−LP1) is less than the difference (L2−L1), an effect similar to that provided by the connector unit 10 according to the present embodiment can be obtained. Specifically, the ground terminal 40 is allowed to contact the counterpart ground terminal 25 before the signal terminal 50 comes into contact with the counterpart signal terminal 26, when the connector 30 and the counterpart connector 20 are becoming mated together.

In the embodiment of the present disclosure, the resilient contact plate 42 and the body 41 of the ground terminal 40 are formed of a single plate material. However, this is not the only option. The resilient contact plate 42 and the body 41 may be formed of different plate materials. In addition, the resilient contact plate 42, the body 41, and the arched contact plate 43 may be formed of different plate materials or of a single plate material.

In the embodiment of the present disclosure, the contact plate 52 and the body 51 in the signal terminal 50 are formed of a single plate material. However, this is not the only option. The contact plate 52 and the body 51 may be formed of different plate materials. In addition, the contact plate 52, the body 51, and the arched contact plate 53 may be formed of different plate materials or of a single plate material.

In the embodiment of the present disclosure, the connector 30 includes two ground terminals 40 and fourteen signal terminals 50. However, this is not the only option, and any number of ground terminals 40 and signal terminals 50 may be used. The connector 30 may include any number of ground terminals 40 and signal terminals 50 other than the numbers illustrated in the present embodiment.

In the embodiment of the present disclosure, the ground terminals 40 are housed in two terminal housing chambers that are located around the center of the upper row in the terminal housing chambers 35 arranged in 8 columns by 2 rows. However, this is not the only option, and thus the ground terminals 40 may be housed in other terminal housing chambers 35.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A connector comprising:
a first terminal comprising:
a first body; and
a first contact plate that is electrically conductive and is supported inside the first body, the first contact plate extending from one opening of the first body toward an other opening of the first body through which a first counterpart terminal is inserted, and including a first contact against which the first counterpart terminal abuts; and
a second terminal comprising:
a second body different from the first body; and
a second contact plate that is electrically conductive and is supported inside the second body, the second contact plate extending from one opening of the second body toward an other opening of the second body through which a second counterpart terminal is inserted, and including a second contact against which the second counterpart terminal abuts,
wherein a first dimension from the other opening of the first body to the first contact is shorter than a second dimension from the other opening of the second body to the second contact.

2. The connector according to claim 1,
wherein the first contact plate extends in a direction parallel to a direction in which the second contact plate extends, and
wherein the other opening of the first body and the other opening of the second body are provided on a plane orthogonal to the direction in which the first contact plate extends.

3. The connector according to claim 1,
wherein the first contact is provided at an end of the first contact plate.

4. The connector according to claim 3,
wherein the first terminal further comprises:
an arched contact plate protruding toward the first contact plate in an arch shape and facing the first contact plate, and
wherein the first contact plate has a shape such that the end of the first contact plate curves toward the arched contact plate and then bends to a side opposite to a curving side.

5. The connector according to claim 1,
wherein the first contact plate and the first body are formed of a single member.

6. The connector according to claim 1,
wherein the first contact plate is formed of a member different from a member forming the first body.

7. The connector according to claim 1, further comprising:
a housing that comprises a first-terminal housing chamber that houses the first terminal and a second-terminal housing chamber that houses the second terminal, the housing being formed of an electrical insulating material.

8. A connector unit comprising:
a connector, the connector including a first terminal and a second terminal, the first terminal including:
a first body; and
a first contact plate that is electrically conductive and is supported inside the first body, the first contact plate extending from one opening of the first body toward an other opening of the first body through which a first counterpart terminal is inserted, and including a first contact against which the first counterpart terminal abuts; and
the second terminal including:
a second body different from the first body; and
a second contact plate that is electrically conductive and is supported inside the second body, the second contact plate extending from one opening of the second body toward an other opening of the second body through which a second counterpart terminal is inserted, and including a second contact against which the second counterpart terminal abuts, wherein a first dimension from the other opening of the first body to the first contact is shorter than a second dimension from the other opening of the second body to the second contact; and
a counterpart connector formed by the first counterpart terminal and the second counterpart terminal, the first and second counterpart terminals being formed from an electrically conductive material, the counterpart connector being mated to the connector,
wherein the connector unit is configured so that the first counterpart terminal abuts against the first contact and then the second counterpart terminal abuts against the second contact when the connector and the counterpart connector are becoming mated together.

9. The connector unit according to claim 8,
wherein the counterpart connector comprises a counterpart housing that is formed of an electrical insulating material and that supports the first counterpart terminal and the second counterpart terminal that are protruding, and
wherein a value obtained by subtracting a length of a protruding portion of the first counterpart terminal from a length of a protruding portion of the second counterpart terminal is less than a value obtained by subtracting the first dimension from the second dimension.

10. The connector unit according to claim 8,
wherein the first contact plate extends in a direction parallel to a direction in which the second contact plate extends, and
wherein the other opening of the first body and the other opening of the second body are provided on a plane orthogonal to the direction in which the first contact plate extends.

11. The connector unit according to claim 8,
wherein the first contact is provided at an end of the first contact plate.

12. The connector unit according to claim 11,
wherein the first terminal further comprises:
an arched contact plate protruding toward the first contact plate in an arch shape and facing the first contact plate, and
wherein the first contact plate has a shape such that the end of the first contact plate curves toward the arched contact plate and then bends to a side opposite to a curving side.

13. The connector unit according to claim 8,
wherein the first contact plate and the first body are formed of a single member.

14. The connector unit according to claim 8,
wherein the first contact plate is formed of a member different from a member forming the first body.

15. The connector unit according to claim 8, further comprising:
a housing that comprises a first-terminal housing chamber that houses the first terminal and a second-terminal housing chamber that houses the second terminal, the housing being formed of an electrical insulating material.
